(19) United States
(12) Patent Application Publication
(10) Pub. No.: US 2014/0030411 A1
(43) Pub. Date: Jan. 30, 2014

(54) SHORTENING COMPOSITIONS AND METHODS FOR FORMING THE SAME

(71) Applicant: Dow AgroSciences LLC, Indianapolis, IN (US)

(72) Inventors: Frank T. Orthoefer, Germantown, TN (US); John D. Keller, JR., Freehold, NJ (US); Jo-Anne Frank, Matawan, NJ (US)

(73) Assignee: Dow AgroSciences LLC, Indianapolis, IN (US)

(21) Appl. No.: 13/950,458

(22) Filed: Jul. 25, 2013

Related U.S. Application Data
(60) Provisional application No. 61/676,248, filed on Jul. 26, 2012.

(51) Int. Cl. A23D 9/04

(52) U.S. Cl. CPC A23D 9/04
USPC 426/541; 426/606

(57) ABSTRACT

The present invention relates to shortening compositions having reduced trans-fatty acids and methods of making the same. Such a shortening composition may include, for example, a mixture of a hard fat, a non-hydrogenated oil and an emulsifier. The shortening compositions may be used to make various food products.

### CROSS-REFERENCE TO RELATED APPLICATION

This application claims the benefit of U.S. Provisional Patent Application Ser. No. 61/676,248, filed Jul. 26, 2012, the disclosure of which is hereby incorporated herein in its entirety by this reference.

### FIELD OF THE INVENTION

The present invention relates to fat products, and more particularly to shortenings having improved properties.

### BACKGROUND OF THE INVENTION

Perceptions of the health effects of trans-fatty acids have undergone several changes in recent years. As used herein, the term “trans-fatty acid” means and includes unsaturated fatty acids that contain one or more isolated (i.e., non-conjugated) double bonds in a trans configuration. Trans-fatty acids, which were once heralded as the healthy alternative to saturated fats, have been associated with serious health risks. Epidemiological and experimental studies suggest that trans-fatty acids increase risk more than do saturated fats because they lower serum high density lipoprotein (HDL) cholesterol. Trans-fatty acids have been shown to have adverse effects on blood lipids, to increase inflammatory markers in blood, and to elevate risks of coronary heart disease.

Trans-fatty acids are produced by partial hydrogenation of vegetable oils. This is a process that converts vegetable oils into semisolid fats, which have no known nutritional value. From the perspective of the food industry, partially hydrogenated vegetable oils are attractive because of their long shelf-life, their stability during deep-frying, and their semi-solid state, which can be customized to enhance the palatability of baked goods and sweets. While they occur naturally in meat from cows, sheep, and other ruminants, dietary trans-fatty acids are found primarily in margarines, vegetable shortening, prepared and packaged baked goods, chips and crackers, commercially prepared fried foods, and fast food and restaurant foods.

Solid fats, such as shortenings (i.e., plastic fats) for example, are used in food manufacturing to provide texture and firmness. Shortenings conventionally include saturated fats or oils formed through various processes (e.g., partial hydrogenation) and sources which result in a significant amount of trans-fatty acids in the composition.

With the scientific evidence associating trans-fatty acid intake with an increased risk of coronary heart disease, the U.S. Food and Drug Administration (FDA) issued a final rule that requires the declaration of the amount of trans-fatty acids present in foods, including dietary supplements, on the nutrition label. Mandatory addition of the content of saturated fats and trans-fatty acids to nutrition labels may enable customers to make healthier food choices that may reduce the risk of coronary heart disease and other vascular events.

Simply reducing the amount of hard fat in conventional hydrogenated shortening compositions undesirably results in reduced functionality and consistency (i.e., too soft of a hydrogenated shortening composition). Thus, conventional methods of forming such hydrogenated shortening compositions have been largely unsuccessful.

### BRIEF SUMMARY OF THE INVENTION

The following embodiments and aspects thereof are described in conjunction with systems, tools and methods which are meant to be exemplary and illustrative, not limiting in scope. Certain embodiments of the invention include a shortening composition that includes a hard fat, a non-hydrogenated vegetable oil and an emulsifier. The hard fat may include at least one of a fully hydrogenated cottonseed oil, a fully saturated soybean oil, a fully saturated palm oil, a non-hydrogenated palm oil stearine, a fully saturated canola oil and a fully hydrogenated canola oil stearine. The non-hydrogenated vegetable oil may include at least one of canola oil, sunflower oil, safflower oil, and soybean oil. As an example, the non-hydrogenated vegetable oil can be a non-hydrogenated canola oil that includes from about 70% to about 77% oleic acid. The emulsifier may include at least one of hard mono- and diglycerides, soft mono- and diglycerides and acetylated mono- and diglycerides. The emulsifier may be present in the shortening composition at amount of about 0.2 wt % to about 10 wt %.

Further embodiments include a shortening composition that includes a hard fat comprising at least one of fully hydrogenated cotton seed flakes, fractionated palm stearine, soybean stearine, and rapeseed stearine, an oil comprising greater than about 70% monounsaturated fatty acids and an emulsifier comprising at least one of hard mono- and diglycerides, soft mono- and diglycerides, and acetylated mono- and diglycerides. The shortening composition may additionally include at least one of citric acid, ascorbic acid, butylated hydroxytoluene and tertiary butylhydroquinone. The shortening composition may include from about 10 wt % to about 35 wt % of the hard fat, from about 75 wt % to about 86 wt % of the oil and from about 0.2 wt % to about 10 wt % of the emulsifier. For example, the oil may include greater than about 70% monounsaturated fatty acids.

Further embodiments include food products made with, or otherwise comprising, a shortening composition of the present invention. In one embodiment, the shortening composition includes high oleic canola oil, a saturated, non-hydrogenated fat and an emulsifier. The food product may be, for example, a cake doughnut mix, raised yeast doughnut mix, sugar cookie mix, frozen biscuit mix, fresh biscuit mix, machined pastry dough, a toaster pastry and an edible product, such as a toaster pastry, that includes the composition.

Further embodiments include methods of making a shortening. Such methods include melting a hard fat and emulsifier into an oil to form a molten mixture and subjecting the molten mixture to a crystallization process to form the shortening composition. Additionally, the hard fat may be combined with the emulsifier before melting the hard fat and the at least one emulsifier into the oil. The molten mixture may be directed into one or more swept surface heat exchangers during the crystallization process. For example, the molten mixture may be cooled to a temperature of from about 15° C. to about 20° C. using the one or more swept surface heat exchangers. The hard fat and the emulsifier may be introduced to the oil at a temperature sufficient to melt the hard fat therein, such as a temperature of from about 60° C. to about 75° C. The method may further include maintaining the shortening composition at a temperature of form about 25° C. to about 35° C.

Further embodiments include shortening compositions that include from about 10 wt % to about 35 wt % of a fully saturated fat, from about 65 wt % to about 90 wt % of a non-hydrogenated oil and from about 0.2 wt % to about 10 wt % of at least one emulsifier, as well as shortening compositions that include a fully saturated, a non-hydrogenated oil, and an emulsifier, wherein said shortening composition is substantially free of trans-fatty acids.

In addition to the exemplary aspects and embodiments described above, further aspects and embodiments will become apparent by study of the following descriptions.

### BRIEF DESCRIPTION OF THE DRAWINGS

FIG. 1 is a schematic representation of an embodiment of a system used to process a shortening composition.

### DETAILED DESCRIPTION OF THE INVENTION

A composition for use as a shortening that includes a hard fat, an oil, and an emulsifier, to create a desired firmness, consistency and plastic character without hydrogenation, as well as methods of forming such a composition, are disclosed. Such compositions are useful as a shortening in a variety of applications. Such compositions may contain a substantially reduced amount of saturated fat in comparison to shortenings made with hydrogenated fats (i.e., hydrogenated shortenings), which are typically used in the industry. To form the composition, an emulsifier may be added to a mixture of the hard fat and the oil, followed by votation. The composition provides shortening having a lower saturated fat content and a modified or increased firmness in comparison with hydrogenated shortenings or non-hydrogenated shortenings in which firmness is achieved via the use of much higher amount of fully saturated hard stock. Since hydrogenation is bypassed, the composition may be substantially free of trans-fatty acids (i.e., a “non-trans” composition).

As used herein, the term “hard fat” refers to a fully saturated fat. The hard fat may include fats from palm, cottonseed, soy, rapeseed, and the like.

As used herein, the term “oil” refers to conventional oils (from olive, sunflower, soy, canola, cottonseed, peanut, etc.) or oils from non-hydrogenated highly monounsaturated fats, such as high oleic acid (i.e., low linolenic acid) canola oil, high oleic acid (i.e., low linoleic acid) soybean oil and/or high oleic acid (i.e., low linolenic acid) sunflower oil

As used herein, the term “trans fat” refers to a type of saturated or partially saturated fat that includes trans-isomer fatty acids.

As used herein, the term “plastic” refers to a solid, non-fluid and non-pourable state that is workable at room temperature.

As used herein, the terms “plasticizing” and “votating” each refer to producing a fine dispersion of solid fat crystals an entrained liquid oil developing a fine crystal structure in order to produce a composition smooth in appearance and firm in consistency.

In one embodiment, the oil may comprise an OMEGA-9 canola oil (a non-hydrogenated canola oil having an oleic acid (18:1) content of about 70% by weight (wt %) to about 77 wt %, and an a-linolenic acid (18:3) content of less than about 3% (marketed by Dow AgroSciences LLC, Indianapolis, Ind.)). In a further embodiment, the oil may comprise an OMEGA-9™ sunflower oil—a non-hydrogenated sunflower oil having an oleic acid (18:1) content of greater than about 80 wt % and an α-linolenic acid (18:3) content of less than about 1 wt % (Dow AgroSciences LLC, Indianapolis, Ind.). In yet a further embodiment, the oil may comprise a soybean oil having an oleic acid (18:1) content of about 70% by weight (wt %) to about 77 wt %, and an α-linolenic acid (18:3) content of less than about 3%. A hard fat and the emulsifier may be combined and melted into the oil to form a molten mixture of the hard fat, the emulsifier and the oil. The molten mixture may be crystallized using a cooling device, such as one or more swept surface heat exchangers. After cooling, the mixture may be held in tempering units for correct crystallization and development. The crystallized mixture may then be extruded for final texture development. Combining one or more non-trans hard fats (i.e., natural or fully saturated) with one or more oils and emulsifiers with subsequent votation according to embodiments of the presently described method provides a substantially trans-fat free shortening composition having the desired properties without using conventional hydrogenation processes that result in formation deleterious trans fats.

In some embodiments, the composition may include from about 5 wt % to about 40 wt % and, more particularly, from about 10 wt % to about 35 wt % of at least one hard fat, and from about 60 wt % to about 95 wt % and, more particularly, from about 65 wt % to about 90 wt % of at least one oil. The hard fat may be substantially free of trans-fatty acids. The hard fat may include, for example, one or more of a non-hydrogenated fully saturated cottonseed oil, a cottonseed oil stearine, a soybean oil, a soybean oil stearine, a palm oil, a palm oil stearine, canola oil, canola oil stearine, a soybean oil, a soybean oil stearine, and stearic acid. As a specific non-limiting example, the hard fat may be a fractionated palm oil stearine the hard fat component may be a high fat composition that includes about 7 wt % of a whole cottonseed oil and about 3 wt % prilled fatty acids (“Cottonseed HF”). As another non-limiting example, the hard fat component may include a palm oil-based product having saturated fat levels in a range of from about 45 wt % to about 48 wt %, a blend of canola oil, palm oil and palm kernel oil having saturated fat levels in a range of from about 20 wt % to about 48 wt %, such as ESSENCE EX36, ESSENCE 8730 and ESSENCE 8633, each of which is commercially available from Aarhus Karlsham AB. Further, the hard fat may include about 20 wt % to about 60 wt %, and more particularly, about 48 wt % lauric acid. In yet another non-limiting example, the hard fat may be a fractionated, non-hydrogenated vegetable fat of non-lauric origin, such as a palm kernal oil flakes or powder (i.e., REVEL A-fractionated, non-hydrogenated, refined vegetable fat derived from palm oil (Loders Croklaan, Channahon, Ill.). Such hard fats may have high melting points (the melting point of REVEL A is 88° C.), an iodine value of about 14, a free fatty acid content of about 0.05 wt %, and a trans fatty acid content of less than about 1 wt %.

The oil may include, for example, one or more of canola oil, sunflower oil, safflower oil, soybean oil, olive oil, cottonseed oil and peanut oil. As previously discussed, the oil may include a high level (i.e., greater than about 70 wt %) of mono-unsaturated fatty acids and a low level (less than about 3 wt %) of linolenic fatty acids, such as, for example, OMEGA-9 canola oil, OMEGA-9 sunflower oil and soybean oil. The use of such high oleic oils is particularly advantageous—as these oils contain 1% or less trans fat, the lowest amount of saturated fat and high levels of heart-healthy monounsaturated fat. In particular embodiments, the sunflower oil has less than 3.3% total saturated fatty acids.

In some embodiments, the composition may include from about 0.1 wt % to about 15 wt % and, more particularly, from about 0.2 wt % to about 10 wt % of an emulsifier. The emulsifier may include, but is not limited to, at least one of hard mono- and diglycerides, soft mono- and diglycerides and acetylated mono- and diglycerides. The emulsifier may have a melting point (M.P.) of from about 40° C. to about 65° C. Examples of such emulsifiers include soft-mono and diglycerides from hydrogenated soybean oil (M.P. 40-49° C.), hard-mono and diglycerides from hydrogenated soybean oil (M.P. 58-65° C.), diacetyl tartaric acid esters of mono- and diglycerides (M.P. 50-60° C.), and combinations thereof. As a non-limiting example, the emulsifier may be BFPO 65K emulsifier or EMPLEX® sodium stearoyl lactylate (SSL) (Caravan Ingredients Inc., Lenexa, Kans.). Including an emulsifier in the composition may substantially reduce saturated fat content in comparison to hydrogenated shortenings. Including soft mono- and diglycerides in the composition may reduce firmness in the composition. As would be understood by one of ordinary skill in the art, combinations of different emulsifiers may be optimized to provide a wide array of different textures and to reduce saturated fat content in the composition.

The composition may optionally include one or more antioxidants. Suitable antioxidants include, but are not limited to, tertiary butylhydroquinone (TBHQ), butylated hydroxyanisole (BHA), butylated hydroxytoluene (BHT), citric acid, ascorbic acid, tocopherol, and the like. Addition of such an antioxidant to the composition may substantially improve the stability of the composition.

For example, the hard fat and the oil may be included in the composition at a ratio of from about 10:90 to about 30:70, and more particularly, about 20:80. In such embodiments, the hard fat may be the fractionated palm oil stearine and the oil may be the OMEGA-9 canola oil. As a non-limiting example, the composition may include from about 10% to about 30% and, more particularly, about 22% saturated fat.

The composition provides a non-hydrogenated (i.e., substantially free of trans-fatty acids), low saturated fat shortening having a desired consistency that is useful in a variety of applications requiring the firmness of a hydrogenated shortening or higher saturated fat shortening. The composition may be included in a food product, such as a cake mix, a cake doughnut mix, a raised yeast doughnut mix, a sugar cookie mix, a frozen biscuit mix, a fresh biscuit mix, a frozen pie crust, a pudding mix, a laminated dough application, such as puff pastry, croissants and turnovers, and a machined pastry dough, or an edible product or composition, such as a toaster pastry or a fried food. For example, an edible composition may be prepared that includes the composition and may be baked. As another non-limiting example, a fried edible composition may be prepared by providing a food product comprising the composition and frying the food product. In some embodiments, the food product may be fried in the composition.

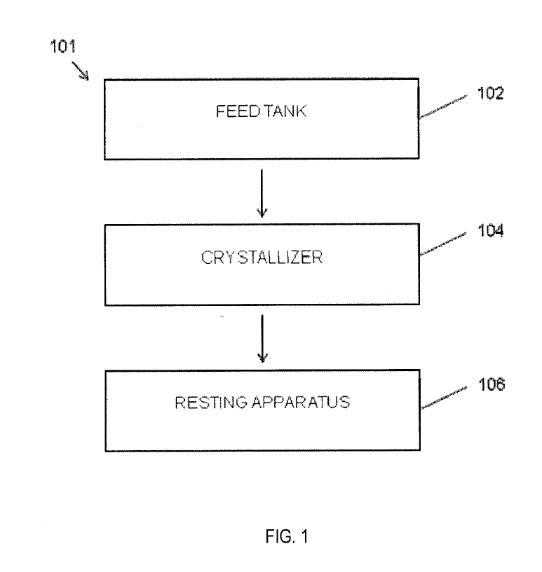

The composition may be pre-formulated into a molten state, cooled, crystallized, tempered and extruded to achieve functionality and plastic character. An embodiment of an apparatus 100 for forming the composition is shown in FIG. 1. The apparatus 100 may include a feed tank 102 for developing the composition in a molten state (i.e., “the molten composition”), a crystallizer 104 for crystallizing and chilling the molten composition and a resting apparatus 106 for tempering the composition. A combination of the hard fat and the emulsifier and may be supplied to the feed tank 102. Optionally, the hard fat and the emulsifier may be mixed prior to being supplied to the feed tank 102, or may be mixed within the feed tank 102. At least one antioxidant may, optionally, be combined with the hard fat and the emulsifier.

In the feed tank 102, combination of the hard fat, the emulsifier and the optional antioxidant may be melted in the oil to form a molten mixture. The oil may be introduced into the feed tank 102 before supplying the combination of the hard fat and the emulsifier, or may be introduced into the feed tank 102 after introducing the combination of the hard fat and the emulsifier. The hard fat, the emulsifier, and the oil may be heated to a temperature sufficient to melt the hard fat into the oil. As a non-limiting example, the combination of the hard fat and the emulsifier may introduced to the oil at a temperature of from about 60° C. to about 75° C. to form the molten mixture of the hard fat, the emulsifier, the optional antioxidant, and the oil.

For example, the molten mixture may include from between about 10 wt % to about 35 wt % of the hard fat, from about 0.2 wt % to about 10 wt % of the emulsifier, from about 65 wt % to about 90 wt % of the oil. From about 50 ppm to about 200 ppm of at least one antioxidant may optionally be present in the molten mixture.

The molten mixture may be stabilized using a crystallization process, such as a plasticizing process (e.g., votation). The molten mixture may be fed into a suitable crystallizer 104, such as one or more surface-swept heat exchangers, where the mixture is stabilized by crystallization such that it acquires a plastic-like consistency. For example, the swept-surface heat exchanger may be a VOTATOR® scrape surface heat exchanger (marketed by SPX Corporation, Charlotte, N.C.). In the crystallizer 104 (i.e., the swept-surface heat exchanger), the molten mixture may be transformed into a fine dispersion of solid fat crystals in entrained liquid oil. As the molten mixture is pumped into the crystallizer 104, it may be cooled to a temperature of from about 15° C. to about 20° C. forming the composition. An inert gas, such as nitrogen gas, may optionally be injected in to the crystallizer 104 along with the molten mixture and may be dispersed in the crystallized fat during cooling such that the cooled composition contains entrained gas. After cooling, the composition may optionally be passed through one or more tubes (not shown) where fat crystals are sheared as the heat of crystallization dissipates. During the plasticizing (i.e., crystallization) process, the temperature of the composition may rise to from about 5° C. to about 10° C.

At room temperature, the composition includes two phases—solid fat crystals and liquid oil—imparting the composition with a plastic-like character. The solid fat crystals are sufficiently finely dispersed in the liquid oil such that they may be held together by internal cohesive forces.

After the plasticizing process, the composition may be directed in to a resting apparatus 106 where it is tempered to facilitate formation of crystals in a stable β′ polymorphic form (i.e., β′-crystals). For example, the composition may be tempered by maintaining the composition at a temperature of from about 25° C. to about 35° C. for from about 24 hours to about 48 hours. During the tempering process, α-polymorphs and β-polymorphs in the composition transform from one crystalline form to another, successively, until the more stable β′-polymorph form is reached. Formation of the β′-crystals during the tempering process results in the composition having a slightly firmer consistency above the tempering temperature and a slightly softer consistency at temperatures below the tempering temperature. Thus, the tempering process may improve plasticity, firmness, creaming properties and performance of the composition.

Incorporating the emulsifier into the hard fat and oil as described with respect to FIG. 1 provides a composition that having the functionality and consistency of a hydrogenated shortening composition, without the formation of deleterious trans-fats.

The following examples serve to explain embodiments of the present invention in more detail. These examples are not to be construed as being exhaustive or exclusive as to the scope of this invention. For purposes of comparing taste, oxidative stability, and baking utility, the shortening compositions of the present invention may be tested against hydrogenated shortenings, which are typically used in the industry, such as hydrogenated cottonseed oil (e.g., CS100).

### EXAMPLE 1

Preparation of Shortening Compositions

The compositions shown in Table 1 were prepared the method described with respect to FIG. 1. Each of compositions A through F were formed from a base including a hard fat comprising fractionated palm stearine and an oil comprising OMEGA-9 canola oil. A ratio of the fractionated palm stearine to the OMEGA-9 canola oil in the base was about 20:80. The emulsifiers were varied in compositions A through F to determine an improvement and/or a modification of the firmness of each composition in comparison to a commercially available hydrogenated shortening. Composition A included the base (i.e., fractionated palm stearine and OMEGA-9 canola oil at a ratio of about 20:80), about 3.5 wt % of a soft mono and diglycerides emulsifier was added to the base to form Composition B, about 5 wt % of the soft mono and diglycerides emulsifier was added to the base to form Composition C, about 3.5 wt % of a hard mono and diglycerides emulsifier was added to the base to form Composition D, about 5 wt % of the hard mono and diglycerides emulsifier was added to the base to form Composition E, and about 10 wt % of diacetyl tartaric acid esters of mono and diglycerides were added to the base to form Composition F.

TABLE 1

| Sample | Peak Force(kg) @ 68-72° F.¹ |
|---|---|
| Composition A | 0.364 |
| Composition B | 0.250 |
| Composition C | 0.293 |
| Composition D | 0.652 |
| Composition E | 0.865 |
| Composition F | 0.661 |
| Comparative Example (hydrogenated | 0.340 |
| shortening) | |

The peak force was determined by compressing the compositions using a TA.XT.Plus Texture Analyzer (marketed by Stable Micro Systems, Godalming, UK) equipped with a P/0.5S spherical probe having a 12.7 mm (0.5 inch) diameter at 72° F. The testing probe was lowered at a speed of 1 mm/sec with a 5 g trigger force. As shown in Table 1, adding an emulsifier to the base enables optimization of a firmness of a shortening composition without using a hydrogenation process that results in formation of trans-fatty acids. Varying a type and an amount of the emulsifier in the base provides shortening compositions having a firmness substantially similar to that of the commercially available hydrogenated shortening or a substantially reduced or increased firmness in comparison to the commercially available hydrogenated shortening. One of ordinary skill in the art would recognize the variations or modifications of firmness that could be made to the compositions by altering the amount or type of emulsifier. As shown in Table 1, the compositions including the hard mono and diglycerides emulsifier (i.e., Compositions D and E) exhibited a substantially increased firmness and include a low saturated shortening composition above typical commercial performance while compositions including the soft mono and diglycerides emulsifier (i.e., Compositions B and C) exhibited a reduced firmness. Combinations of these different emulsifiers provide a wide array of different texture adjustments to a low saturate content shortening system.

### EXAMPLE 2

Preparation of a Cookie Using Embodiments of the Composition as a Shortening

Shortening compositions were prepared using fractionated palm stearine as a hard fat and OMEGA-9 canola oil as the oil. A cookie dough was prepared by mixing the shortening (about 34 wt %), granulated sugar (about 32 wt %), liquid whole egg (about 8.5 wt)%, salt (about 0.3 wt %), sodium bicarbonate (about 0.3 wt %) and flour (about 24.4 wt %). The cookie dough was prepared using one of three shortening compositions (Shortening A, Shortening B, and Shortening C).

Shortening A included a mixture of fractionated palm stearine and OMEGA-9 canola oil in a ratio of about 20:80. Shortening B included a mixture of the fractionated palm stearine and the OMEGA-9 canola oil in a ratio of about 20:80 and about 5 wt % a hard mono and diglycerides emulsifier. Shortening C, which was used as a comparative example, was a commercially available hydrogenated vegetable shortening.

Using a 5 Qt. KITCHEN AID® Mixer, the granulated sugar and shortening were mixed (4 minutes) to uniformity using a paddle blade stirring attachment at low speed. The liquid whole egg and the vanilla flavoring were then combined with the mixture and mixed for about 3 minutes at low speed. The flour, sodium bicarbonate and salt were added and mixed into the mixture at low speed for about 3 minutes.

The cookie dough was placed on baking trays with a 16 g scoop to provide cookies having a set volume application. Surfaces of each of the portions of cookie dough were leveled using a spatula such that each had a substantially uniform shape. The cookie dough was baked at a temperature of about 204° C. (about 400° F.) for 4 minutes.

After baking, the cookies prepared using Shortening A, Shortening B and Shortening C were observed. The cookies prepared using the shortening including the emulsifier (Shortening B) exhibited a substantially increased firmness and a reduced spread in comparison to those formed using the commercially available hydrogenated vegetable shortening (Shortening C) and the shortening without the emulsifier (Shortening B). Importantly, the saturated fat content of Shortenings B and C were not substantially increased in comparison to that of Shortening A. Lack of spread in cookie dough handling is an important feature in processing, especially when cookies are wire cut from an extruded dough roll during continuous processing. Addition of an emulsifier as described herein enables use of a substantially trans-fat free shortening in such applications.

### EXAMPLE 3

Preparation of a Cookie Using Embodiments of the Composition as a Shortening

Healthy shortening compositions containing added (integral) emulsifiers for functional improvement were evaluated in a typical yellow cake recipe against a commercial shortening and a control base shortening whereby the emulsifier was added separately during cake batching.

A cake composition was prepared that includes between about 22 wt % and about 32 wt % sugar, between about 25 wt % and about 35 wt % flour, between about 10 wt % and about 18 wt % of a shortening composition, between about 3 wt % and about 14 wt % whole eggs, between about 3 wt % and about 14 wt % milk, between about 0.5 wt % and about 1 wt % of a leavening agent (i.e., baking powder), between about 0.2 wt % and about 0.6 wt % salt, and, optionally, between about 0.2 wt % and about 0.7 wt % of a flavoring. Seven (7) different cake compositions were prepared, each including one of Shortenings 1 through 7. The cake composition made from Shortenings 1 and 2 additionally included between about 0.2 wt % and about 0.6 wt % of an emulsifier, since an emulsifier was included in Shortenings 1 and 2. Shortening 1 was a conventional hydrogenated shortening composition. Shortenings 1 through 7 were each formed from a hard fat (i.e., fractionated palm stearine) and an oil (i.e., OMEGA-9 canola oil) at a ratio of 20:80 using the method described with respect to FIG. 1. Shortenings 3 through 7 additionally included an emulsifier. Shortening 3 was formed from a fractionated palm stearine, OMEGA-9 canola oil and about 3.5 wt % of a soft mono and diglycerides emulsifier. Shortening 4 was formed from a fractionated palm stearine, OMEGA-9 canola oil and about 5 wt % of the soft mono and diglycerides emulsifier. Shortening 5 was formed from a fractionated palm stearine, OMEGA-9 canola oil and about 3.5 wt % of a hard mono and diglycerides emulsifier. Shortening 6 was formed from a fractionated palm stearine, OMEGA-9 canola oil and about 5 wt % of the hard mono and diglycerides emulsifier. Shortening 7 was formed from a fractionated palm stearine, OMEGA-9 canola oil and about 10 wt % of diacetyl tartaric acid esters of monoglycerides (DATEM).

The combinations were found by various subjective (taste panel) and objective evaluation (cake height, cake volume, batter specific gravity and texture analysis) to be substantially similar or substantially superior to cake composition made with the hydrogenated (trans-fat containing) shortening (Shortening 1).

TABLE 2

| | | mean of triplicate readings | | | |
|---|---|---|---|---|---|
| | mean two cakes | Firmness | Springiness | | |
| Shortening | Volume (ml) | (g) | (%) | Organoleptic Comments | Appearance |
| Shortening 1 | 1791 | 602 | 46 | No off flavor, tender, | Tight grain, some |
| | | | | slightly dry | tunneling |
| Shortening 2 | 1838 | 400 | 47 | Moist, very tender, good | Similar to |
| | | | | flavor | Shortening 1 |
| Shortening 3 | 1765 | 383 | 47 | Very slight difference in | Nice X-sectional |
| | | | | taste vs. Shortening 1 | grain, no |
| | | | | Very slight firmer crumb | tunneling |
| | | | | vs. Shortening 1 | |
| Shortening 4 | 1738 | 442 | 45 | More flavor masking of | Higher crown, |
| | | | | vanilla and more cereal | same appearance |
| | | | | taste vs. Shortening 3 | Shortening 3 |
| | | | | Tenderness & moistness | |
| | | | | similar to Shortening 3 | |
| Shortening 5 | 1738 | 455 | 45 | A tad bit firmer & drier | Good grain, some |
| | | | | than the base only, no off | pockets, lacks |
| | | | | flavor | crown |
| Shortening 6 | 1762 | 535 | 43 | Very firm crumb & almost | Same as |
| | | | | tends to “ball” in mouth | Shortening 5 |
| Shortening 7 | 1628 | 643 | 45 | Extremely chewy | Dense crumb, |
| | | | | (gummy), slightly acid | gummy surface |
| | | | | odor and aftertaste | layer, poor crown |

To determine firmness and springiness, a texture analyzer was used. Firmness was calculated as the weight in grams needed to break the top layer of the cake. Springiness was calculated as the percent elasticity of the cake when pressed from the top by an inch, and measured as the percent of return upon release.

As shown in Table 2, incorporation of emulsifiers into shortening compositions prepared from hard fat and oil components substantially free of trans-fatty acids and having lower saturated fat content provides equivalent or improved performance in yellow cakes in comparison with commercially available hydrogenated shortening. In particular, incorporation of the emulsifier into the hard fat and oil-containing composition improves or maintains firmness, improves cross-sectional grain appearance & crown development while maintaining desired cake volume.

While the invention may be susceptible to various modifications and alternative forms, specific embodiments have been shown by way of example in the drawings and have been described in detail herein. However, it should be understood that the invention is not limited to the particular forms disclosed. Rather, the invention encompasses all modifications, variations and alternatives falling within the scope of the invention as defined by the following appended claims and their legal equivalents.

What is claimed is:

1. A shortening composition, comprising:
a hard fat;
a non-hydrogenated oil; and
an emulsifier.

2. The shortening composition of claim 1, wherein the hard fat comprises at least one of a fully saturated cottonseed oil, a fully saturated soybean oil, a fully saturated palm oil, a fully saturated canola oil.

3. The shortening composition of claim 1, wherein the non-hydrogenated oil comprises at least one of canola oil, sunflower oil, safflower oil, and soybean oil.

4. The shortening composition of claim 1, the non-hydrogenated oil comprises a non-hydrogenated canola oil comprising from about 70% to about 77% oleic acid and less than about 3% a-linolenic acid.

5. The shortening composition of claim 1, the non-hydrogenated oil comprises a non-hydrogenated sunflower oil comprising greater than about 80% oleic acid.

6. The shortening composition of claim 1, further comprising at least one antioxidant.

7. The shortening composition of claim 1, wherein the hard fat comprises at least one of fully hydrogenated cotton seed flakes, fractionated palm stearine, soybean stearine, and rapeseed stearine present in an amount of about 10 wt % to about 35 wt %.

8. The shortening composition of claim 1, wherein the hard fat comprises a palm oil-based product having saturated fat levels in a range of from about 45% to about 48%.

9. The shortening composition of claim 1, wherein the non-hydrogenated oil comprises non-hydrogenated soybean oil

10. The shortening composition of claim 1, wherein the emulsifier comprises at least one of hard mono- and diglycerides, soft mono- and diglycerides, and acetylated mono- and diglycerides.

11. The shortening composition of claim 1, wherein the emulsifier is present in the shortening composition at amount of about 0.2 wt % to about 10 wt %.

12. The shortening composition of claim 1, wherein the emulsifier comprises soft-mono and diglycerides from at least one of hydrogenated soybean oil and hard mono and diglycerides from hydrogenated soybean oil.

13. The shortening composition of claim 1, wherein the non-hydrogenated oil comprises sunflower oil having less than 3.3% total saturated fatty acids.

14. A shortening composition comprising:
a hard fat comprising at least one of fully hydrogenated cotton seed flakes, fractionated palm stearine, soybean stearine, and rapeseed stearine;
an oil comprising greater than about 70% monounsatured fatty acids; and
an emulsifier comprising at least one of hard mono- and diglycerides, soft mono- and diglycerides, and acetylated mono- and diglycerides.

15. The shortening composition of claim 14, further comprising at least one of citric acid, ascorbic acid, butylated hydroxytoluene, and tertiary butylhydroquinone.

16. The shortening composition of claim 14, wherein the hard fat comprises from about 10 wt % to about 35 wt % of the composition and wherein the oil comprises from about 75 wt % to about 86 wt % of the composition.

17. The shortening composition of claim 14, wherein the oil comprises greater than about 70% monounsatured fatty acids.

18. A food product comprising a shortening composition, the shortening composition comprising a high oleic canola oil, a saturated, non-hydrogenated fat, and an emulsifier.

19. The food product of claim 18, wherein the high oleic canola oil comprises greater than 70% oleic acid.

20. A method of making a shortening composition, comprising:
melting a hard fat and an emulsifier into an oil to form a molten mixture; and
subjecting the molten mixture to a crystallization process to form the shortening composition.

21. The method of claim 20, further comprising combining the hard fat with the emulsifier before melting the hard fat and the at least one emulsifier into the oil.

22. The method of claim 20, wherein subjecting the molten mixture to a crystallization process to form the shortening composition comprises directing the molten mixture into one or more swept-surface heat exchangers.

23. The method of claim 20, wherein subjecting the molten mixture to a crystallization process to form the shortening composition comprises cooling the molten mixture to a temperature of from about 15° C. to about 20° C.

24. The method of claim 20, wherein melting a hard fat and an emulsifier into an oil to form a molten mixture comprises introducing the hard fat and the emulsifier into the oil at a temperature sufficient to melt the hard fat.

25. The method of claim 24, wherein introducing the hard fat and the emulsifier into the oil at a temperature sufficient to melt the hard fat comprises introducing the hard fat and the emulsifier to the oil at a temperature of from about 60° C. to about 75° C.

26. The method of claim 20, wherein subjecting the molten mixture to a crystallization process comprises subjecting a molten mixture comprising from between about 10 wt % to about 35 wt % of the hard fat, from about 0.2 wt % to about 10 wt % of the emulsifier, from about 65 wt % to about 90 wt % of the oil to the crystallization process.

27. The method of claim 20, further comprising maintaining the shortening composition at a temperature of form about 25° C. to about 35° C. for from about 24 hours to about 48 hours.

28. The method of claim 20, further comprising introducing an inert gas into the molten mixture while subjecting the molten mixture to the crystallization process.

29. A shortening composition, comprising:
from about 10 wt % to about 35 wt % of a fully saturated fat;
from about 65 wt % to about 90 wt % of a non-hydrogenated oil; and
from about 0.2 wt % to about 10 wt % of at least one emulsifier.

30. The shortening composition of claim 29, wherein the fully saturated, fat comprises at least one of a palm oil, a cottonseed oil, a soy oil, a rapeseed oil, and pure stearic acid.

31. The shortening composition of claim 29, wherein the non-hydrogenated oil comprises at least one of olive oil, sunflower oil, soy oil, canola oil, cottonseed oil, peanut oil, high oleic acid canola oil, high oleic acid soybean oil, and high oleic acid sunflower oil.

32. The shortening composition of claim 29, wherein the emulsifier comprises at least one of hard mono- and diglycerides, soft mono- and diglycerides, and acetylated mono- and diglycerides.

33. A shortening composition comprising a fully saturated, non-hydrogenated fat, a non-hydrogenated oil, and an emulsifier, wherein the shortening composition is substantially free of trans-fatty acids.

34. The shortening composition of claim 33, wherein the non-hydrogenated liquid oil comprises greater than about 70% oleic acid.
